(19) United States
(12) Patent Application Publication
(10) Pub. No.: US 2026/0091837 A1
(43) Pub. Date: Apr. 2, 2026

(54) APPARATUS FOR ALIGNING VEHICLE BODY COMPONENTS FOR MOBILITY VEHICLE, AND SYSTEM AND METHOD FOR MOUNTING VEHICLE BODY COMPONENTS FOR MOBILITY VEHICLE

(71) Applicants: Hyundai Motor Company, Seoul (KR); Kia Corporation, Seoul (KR)

(72) Inventors: Ji Hwan Jung, Hwaseong, Gyeonggi-do (KR); Dong Wook Lee, Hwaseong, Gyeonggi-do (KR); Jong Chol Seo, Hwaseong, Gyeonggi-do (KR); Hyo Jae Lee, Hwaseong, Gyeonggi-do (KR); Seon Woo Kweon, Hwaseong, Gyeonggi-do (KR); Keun Soo Lee, Hwaseong, Gyeonggi-do (KR); Dong Chae, Hwaseong, Gyeonggi-do (KR); Hae Jung Kang, Hwaseong, Gyeonggi-do (KR)

(21) Appl. No.: 19/110,718

(22) PCT Filed: Dec. 20, 2022
(86) PCT No.: PCT/KR2022/020788

§ 371 Date: Mar. 11, 2025

(30) Foreign Application Priority Data
Oct. 4, 2022 (KR) 10-2022-0126504

(51) Int. Cl. B62D 65/02

(52) U.S. Cl. CPC B62D 65/026; B62D 65/022; B62D 65/028

(57) ABSTRACT

According to the present invention, vehicle body components are mounted to the correct positions in various types of mobility vehicles. That is, provided are a system and a method for mounting vehicle body components for mobility vehicles, wherein stable support is provided for various types of mobility vehicles according to the shapes of regions to which the vehicle body components are mounted, thus minimizing deviation in the assembly of the vehicle body components, and installation defects and deviations in assembly are reduced through the examination and adjustment of the mounting positions of the vehicle body components, thus improving the commercial value thereof.

### TECHNICAL FIELD

The present disclosure relates to a system and method for mounting vehicle body components for mobility vehicles and, more particularly, to an apparatus for aligning vehicle body components for mobility vehicles and a system and method for mounting vehicle body components for mobility vehicles, which ensure that body components are mounted to the correct positions in various types of mobility vehicles.

### BACKGROUND ART

In general, for mobility production, various vehicle body components undergo assembly and welding processes within the mass production process.

For example, after vehicle body panels are produced by press work, the vehicle body panels are moved to a vehicle body factory and each part of the vehicle body is assembled to form a body in white (BIW).

The completed body frame goes through the installation process of doors, hoods, trunk lids, tailgates, and fenders. The vehicle body is then moved to a painting chamber and painted, and is completed by assembling powertrain parts, interior materials, and exterior materials in the assembling process.

Body components such as panels mounted on a vehicle body are manufactured through press processing, and at a body assembly line, tasks such as assembly, welding, sealing, and hemming are performed while the panels are seated and fixed in a panel jig device, and painting work is performed in the painting process.

In the vehicle body assembly process, various body components such as doors, hoods, trunk lids, and tailgates are moved to the vehicle body by means of dedicated mounting jigs, and the body components are bolted into place by human workers manually or automatically assembled using robots.

In the conventional vehicle body components mounting system as above, when a vehicle body is transported along a transfer rail and placed in position, a set mounting jig or a jig operated by a robot moves a panel to the vehicle body, and then the installation of the vehicle body components is completed by the operation of an assembly robot.

However, it is difficult for the conventional vehicle body components mounting system to respond to variation in a vehicle body at locations to which moving body components such as door hinges are mounted, and the vehicle body variation causes problems of lowering the marketability of a finished vehicle as installation defects and deviations in assembly are likely to occur when installing a door hinge, which is positioned by a jig or clamping device that is set to always move to a set position, on the vehicle body.

Moreover, vehicle bodies are designed in various ways depending on the type of mobility, but there is a problem in that dedicated robots and jigs need to be replaced in order to properly position door hinges for each vehicle body.

An example of related art in this regard is Korean Patent Application Publication No. 10-2021-0151347.

The description provided above as related art of the present disclosure is just for helping understand the background of the present disclosure and should not be construed as being included in the related art known by those skilled in the art.

### DISCLOSURE

### Technical Problem

The present disclosure is intended to solve the above problems occurring in the related art. An objective of the present disclosure is to provide an apparatus for aligning vehicle body components for mobility vehicles and a system and method for mounting vehicle body components for mobility vehicles, which ensure that vehicle body components are mounted to the correct positions in various types of mobility vehicles.

### Technical Solution

In order to achieve the above mentioned objectives, there is provided an apparatus for aligning vehicle body components for mobility vehicles, the apparatus including: an alignment module provided with an alignment unit configured to be movable to position a vehicle body component on a first side of a mounting part, which is a part where the vehicle body component is mounted in a mobility vehicle body; and a fixing module provided with a support unit configured to contact a second side of the mounting part, wherein the support unit is designed to match an outer shape of the mounting part.

The alignment module and the fixing module may be configured as one device such that the fixing module is mounted on the alignment module, and the alignment module and the fixing module may be arranged to face each other but are spaced apart, so that the mounting part of a mobility vehicle is located between the alignment unit and the support unit.

The alignment module may include: a base on which a support panel is provided; the alignment unit movably installed on the base and provided with a clamp unit to which the vehicle body component is fixed; and a first operation part installed on the alignment unit and connected to the support panel so as to move the alignment unit away from or closer to the support panel during operation.

The a direction in which the alignment unit is moved away from or closer to the support panel may be set according to a direction of a position tolerance of the mounting part, and a range by which the alignment unit is moved away from or closer to the support panel may be set according to a degree of the position tolerance of the mounting part.

The clamp unit may include: a seating part fixed to the alignment unit and provided to seat the vehicle body component; a pressing part provided to be movable toward the seating part and configured to press and fix the vehicle body component seated on the seating part; and a second operation part installed in the alignment unit and connected to the pressing part so as to move a position of the pressing part during operation.

The pressing part may be provided to be tiltable in a moving direction, a plurality of second operation parts may be provided and arranged vertically, and the second operation parts may be connected to be spaced apart in a vertical direction with the pressing part in between.

The fixing module may include: a link arm installed to be moved on the alignment module and equipped with the support unit; and a third operation part installed on the alignment module and connected to the link arm to adjust a position of the link arm.

The support unit may be mounted on the link arm via a fourth operation part, and the fourth operation part may be configured to move in a straight line so that a position of the support unit is changed.

The support unit may include: a housing configured to have an internal space and an open surface; and a pin unit configured to have a plurality of support pins provided to protrude through the open surface in the internal space of the housing and elastically supported to change protrusion lengths thereof.

The apparatus may further include a component support module configured to contact the vehicle body component and fix a position of the vehicle body component in a state where the vehicle body component is positioned on the first side of the mounting part by the alignment unit of the alignment module while the support unit of the fixing module contacts and supports the second side of the mounting part.

The component support module may include: a support arm configured to move toward the fixed vehicle body component by means of the alignment unit and contact the vehicle body component; and a fifth operation part installed in the alignment unit and connected to the support arm so as to allow, when operated, the support arm to move toward the vehicle body component and make contact with the vehicle body component.

The apparatus may further include a scanner module configured to scan the mounting part of the mobility vehicle and check a position of the vehicle body component located on the mounting part by the alignment module; and a control module configured to compare information input through the scanner module with a previously stored database to identify a normal position of the vehicle body component, and to control the alignment module and the fixing module to adjust the position of the vehicle body component when the position of the vehicle body component is determined to deviate from the normal position.

Meanwhile, a system for mounting vehicle body components for mobility vehicles according to the present disclosure may include: a bin picking robot configured to take out a vehicle body component that meets specifications of a mobility vehicle; an alignment jig configured to seat the vehicle body component taken out by the bin picking robot and align the seated vehicle body component at an installation angle with respect to a mounting part; a loading robot configured to transfer the vehicle body component seated on the alignment jig to the mounting part, a part where the vehicle body component is mounted in a mobility vehicle body, and allow the vehicle body component to contact the mounting part with a certain pressure while supporting the mounting part; and a fastening robot configured to fasten the vehicle body component to the mounting part.

The loading robot may include: an alignment module provided with an alignment unit for fixing the vehicle body component; a fixing module designed to match an outer shape of the mounting part on a second side of the mounting part where the vehicle body component is to be mounted; and a component support module configured to contact the vehicle body component and fix a position of the vehicle body component while the vehicle body component and a support unit are positioned in the mounting part.

The alignment jig may include: a support provided to seat the vehicle body component; a first regulating device configured to regulate a first side of the vehicle body component, and a first driving part configured to operate the first regulating device; and a second regulating device configured to regulate a second side of the vehicle body component, and a second driving part configured to operate the second regulating device.

The fastening robot may allow a fastening means to penetrate the vehicle body component and the mounting part fixed by the loading robot, so that the vehicle body component is fixed to the mounting part.

Meanwhile, a method for mounting vehicle body components for mobility vehicles to properly position and mount the vehicle body components on a mobility vehicle body according to the present disclosure may include: taking out in which a vehicle body component is taken out by a bin picking robot on a basis of mobility information; aligning in which the taken-out vehicle body component is transferred to an alignment jig and seated on the alignment jig; preparing fastening in which the vehicle body component is positioned on a first side of a mounting part of a mobility vehicle by an alignment module of a loading robot while a fixing module is brought into contact with a second side of the mounting part, and a component support module is brought into contact with the vehicle body component; and fastening in which the vehicle body component is fastened to the mounting part via a fastening means by a fastening robot.

In the aligning, the seated vehicle body component may be aligned at an installation angle for the mounting part of the mobility vehicle on the basis of the mobility information.

The method may further include checking, after the preparing fastening, in which a position of the vehicle body component is checked and whether the position of the vehicle body component is normal is determined on a basis of a database by a scanner module.

The method may further include adjusting in which the alignment module and the fixing module are controlled to adjust the position of the vehicle body component when the position of the vehicle body component is determined, in the checking, to deviate from the normal position.

### Advantageous Effects

According to an apparatus having the structure described above for aligning vehicle body components for mobility vehicles and a system and method for mounting vehicle body components for mobility vehicles, body components can be installed in correct positions for various types of mobilities.

That is, since stable support is provided in response to the shape of a part to which a body component is mounted in various types of mobility vehicles, deviations in assembly of body components can be minimized, and through examination and adjustment of body component mounting positions, installation defects and deviations in assembly can be reduced, improving marketability.

### DESCRIPTION OF DRAWINGS

FIG. 1 is a view showing an alignment module, a fixing module, and a component support module according to an apparatus for aligning vehicle body components for mobility vehicles according to the present disclosure;

FIG. 2 is a view showing the alignment module and the fixing module on one side of a mounting part;

FIG. 3 is a view showing the alignment module and the fixing module on the other side of the mounting part;

FIG. 4 is a side view of the alignment module, the fixing module, and the component support module shown in FIG. 1;

FIG. 5 is a view showing a clamp unit according to an embodiment of the present disclosure;

FIG. 6 is a view showing the direction of tolerance according to mounting a vehicle body part to the mounting part in the present disclosure;

FIG. 7 is a view showing a support unit according to the present disclosure;

FIG. 8 is a view showing the operating state of the support unit shown in FIG. 7;

FIG. 9 is a view showing each robot in a system for mounting vehicle body components for mobility vehicles according to an embodiment of the present disclosure;

FIG. 10 is a view showing a process of taking out a vehicle body component using a bin picking robot in the system for mounting vehicle body components for mobility vehicles of the present disclosure;

FIG. 11 is a view showing an alignment process in which a vehicle body component is aligned by means of an alignment jig in the system for mounting vehicle body components for mobility vehicles of the present disclosure;

FIG. 12 is a view showing the state before operation of the alignment jig shown in FIG. 11;

FIG. 13 is a view showing the state after operation of the alignment jig shown in FIG. 11;

FIG. 14 is a view showing an examination process using a scanner module in the system for mounting vehicle body components for mobility vehicles of the present disclosure;

FIG. 15 is a view showing a process in which a vehicle body component is placed in the mounting part by a loading robot in the system for mounting vehicle body components for mobility vehicles of the present disclosure;

FIG. 16 is a view showing a fastening process in which a vehicle body component is fastened to the mounting part by a fastening robot in the system for mounting vehicle body components for mobility vehicles of the present disclosure;

FIG. 17 is a flowchart of a method for mounting vehicle body components for mobility vehicles of the present disclosure; and

FIG. 18 is a detailed flowchart of the method for mounting vehicle body components for mobility vehicles according to an embodiment of the present disclosure.

### MODE FOR INVENTION

Hereafter, the embodiment of the present disclosure will be described in detail with reference to the accompanying drawings, but identical or similar components are given the same reference numerals regardless of the numbers in the drawings, and redundant descriptions thereof will be omitted.

The terms “module” and “unit” that are used for components in the following description are given or used interchangeably only for the ease of writing the specification, and do not have distinct meanings or roles in themselves.

In the following description, if it is decided that the detailed description of known technologies related to the present disclosure makes the subject matter of the embodiment described herein unclear, the detailed description is omitted. In addition, the accompanying drawings are provided only for easy understanding of the embodiment disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

Singular forms are intended to include plural forms unless the context clearly indicates otherwise.

It will be further understood that the terms “comprise (include)” or “have” used in this specification, specify the presence of stated features, steps, operations, components, parts, or a combination thereof, but do not preclude the presence or addition of one or more other features, numerals, steps, operations, components, parts, or a combination thereof.

In addition, the terms “unit” or “control unit” included in motor control unit (MCU), hybrid control unit (HCU), etc. are just widely used terms for naming controllers that control specific vehicle functions, and do not mean generic function units.

A controller may include a communication device that communicates with another controller or a sensor to control corresponding functions, a memory that stores an operating system or logic commands and input/output information, and one or more processors that perform determination, calculation, decision, etc. for controlling the corresponding functions.

Hereinafter, a system and method for mounting vehicle body components for mobility vehicles according to preferred embodiments of the present disclosure will be described with reference to the attached drawings.

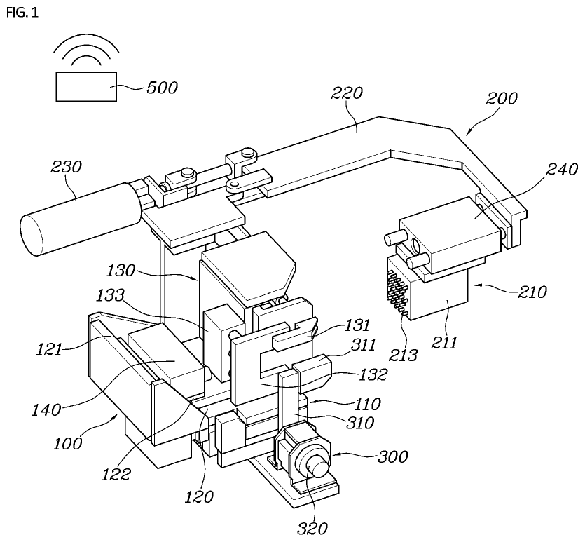

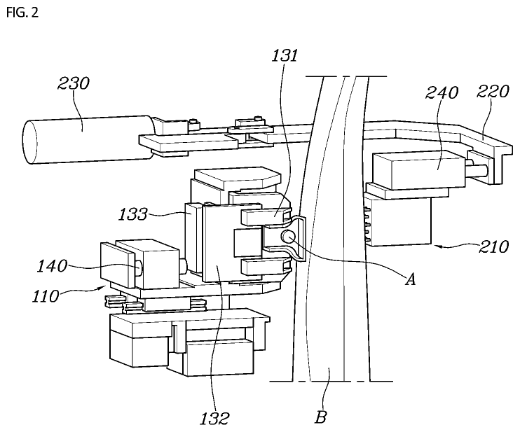

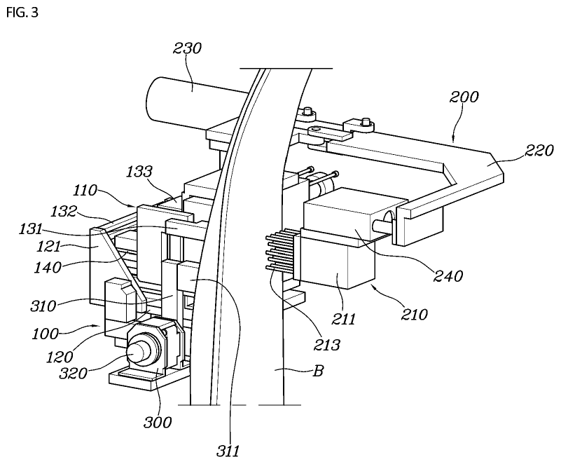

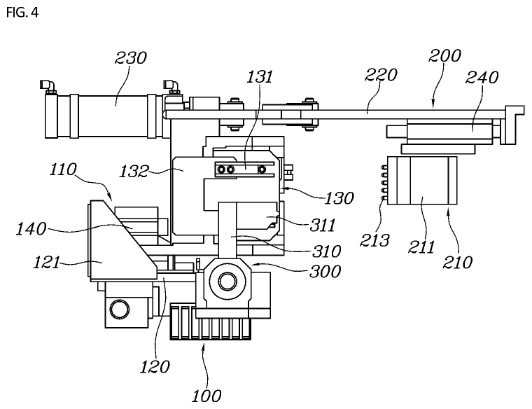

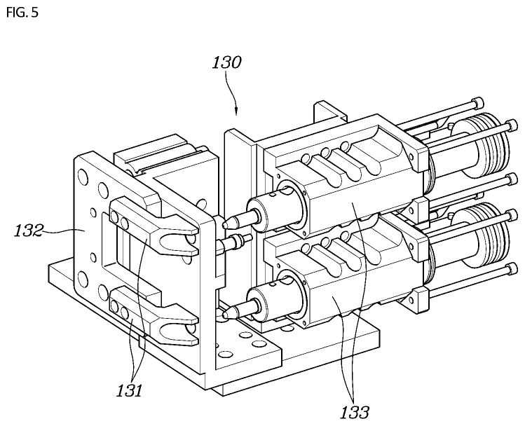

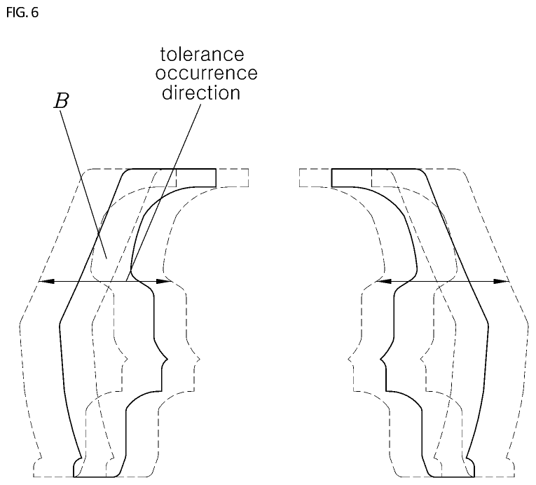

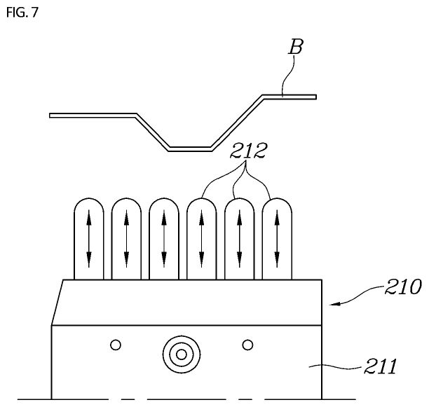

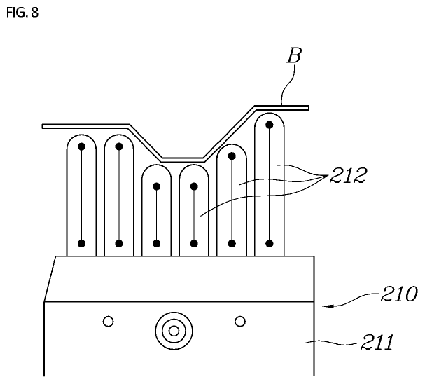

FIG. 1 is a view showing an alignment module, a fixing module, and a component support module according to an apparatus for aligning vehicle body components for mobility vehicles according to the present disclosure, FIG. 2 is a view showing the alignment module and the fixing module on one side of a mounting part, FIG. 3 is a view showing the alignment module and the fixing module on the other side of the mounting part, FIG. 4 is a side view of the alignment module, the fixing module, and the component support module shown in FIG. 1, FIG. 5 is a view showing a clamp unit according to an embodiment of the present disclosure, FIG. 6 is a view showing the direction of tolerance according to mounting a vehicle body part to the mounting part in the present disclosure, FIG. 7 is a view showing a support unit according to the present disclosure, and FIG. 8 is a view showing the operating state of the support unit shown in FIG. 7.

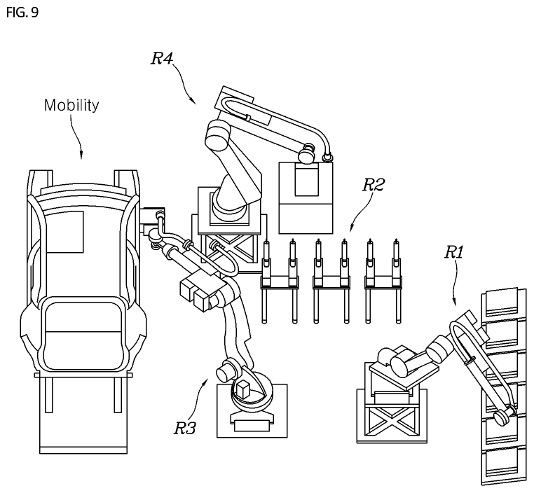

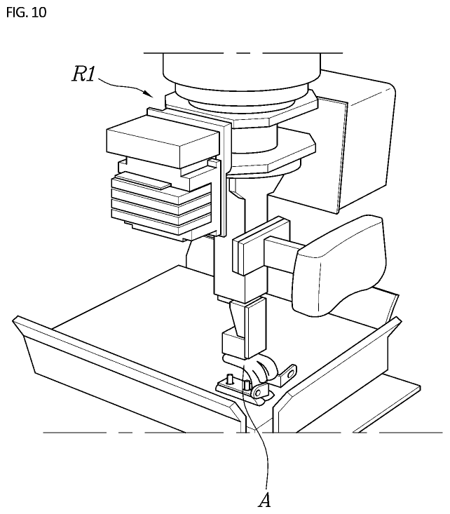

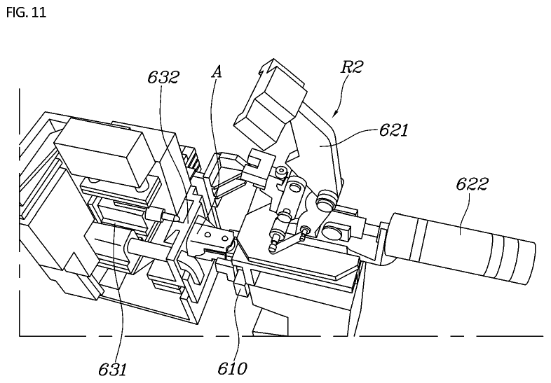

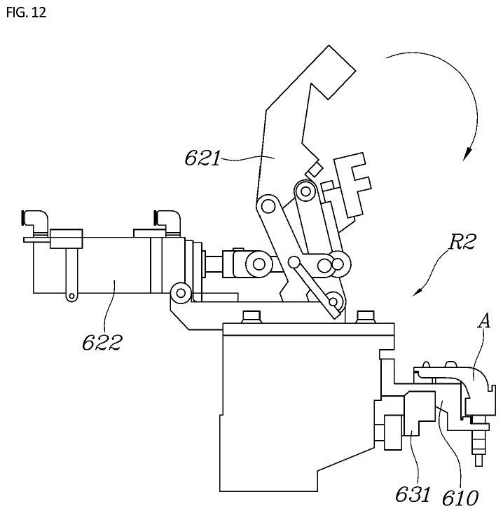

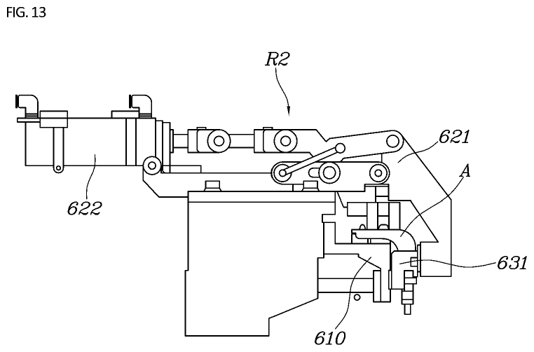

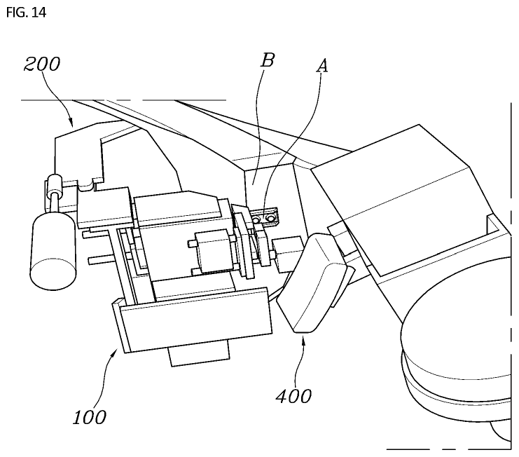

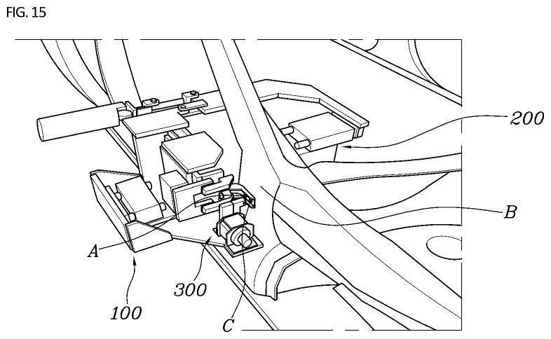

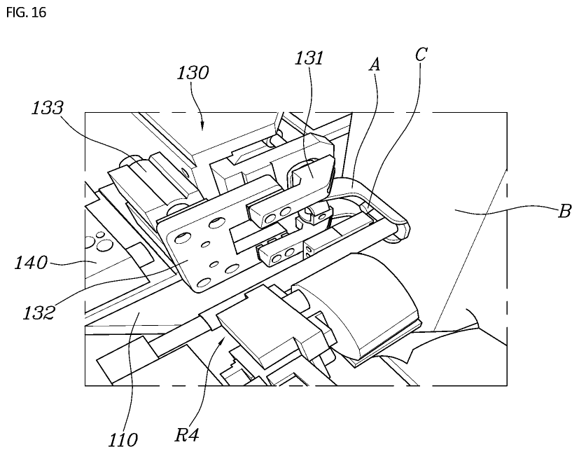

Meanwhile, FIG. 9 is a view showing each robot in a system for mounting vehicle body components for mobility vehicles according to an embodiment of the present disclosure, FIG. 10 is a view showing a process of taking out a vehicle body component using a bin picking robot in the system for mounting vehicle body components for mobility vehicles of the present disclosure, FIG. 11 is a view showing an alignment process in which a vehicle body component is aligned by means of an alignment jig in the system for mounting vehicle body components for mobility vehicles of the present disclosure, FIG. 12 is a view showing the state before operation of the alignment jig shown in FIG. 11, FIG. 13 is a view showing the state after operation of the alignment jig shown in FIG. 11, FIG. 14 is a view showing an examination process using a scanner module in the system for mounting vehicle body components for mobility vehicles of the present disclosure, FIG. 15 is a view showing a process in which a vehicle body component is placed in the mounting part by a loading robot in the system for mounting vehicle body components for mobility vehicles of the present disclosure, and FIG. 16 is a view showing a fastening process in which a vehicle body component is fastened to the mounting part by a fastening robot in the system for mounting vehicle body components for mobility vehicles of the present disclosure.

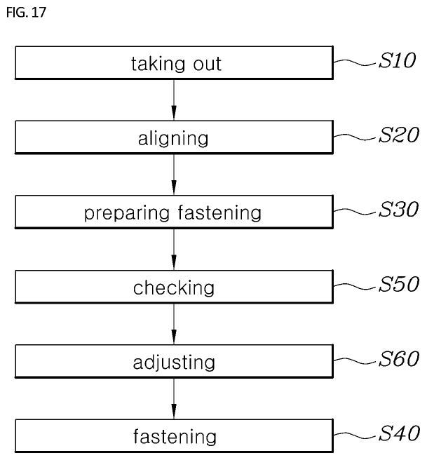

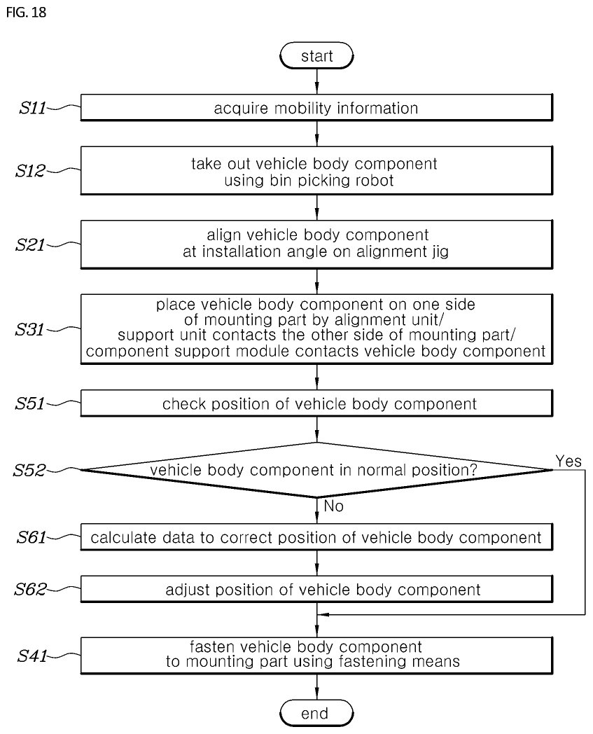

Meanwhile, FIG. 17 is a flowchart of a method for mounting vehicle body components for mobility vehicles of the present disclosure, and FIG. 18 is a detailed flowchart of the method for mounting vehicle body components for mobility vehicles according to an embodiment of the present disclosure.

As shown in FIGS. 1 to 4, the apparatus for aligning vehicle body components for mobility vehicles according to the present disclosure includes: an alignment module 100 provided with an alignment unit 110 that positions a vehicle body component A on one side of a mounting part B, which is the part where the vehicle body component A is mounted in a mobility vehicle body; a fixing module 200 provided with a support unit 210 that is in contact with the other side of the mounting part B, wherein the support unit 210 is designed to match the outer shape of the mounting part B; and a component support module 300 that contacts the vehicle body component A and fixes the position of the vehicle body component A in a state where the vehicle body component A is positioned on one side of the mounting part B while the support unit 210 of the fixing module 200 contacts and supports the other side of the mounting part B.

The present disclosure ensures that in the process of assembling the vehicle body component A to the mobility vehicle body, when the vehicle body component A is mounted on the vehicle body transported along a vehicle body assembly line, the mounting position of the vehicle body component A is maintained at the correct position.

Particularly, the present disclosure relates to the installation of a door hinge among a plurality of vehicle body components A, and may also be applied to other vehicle body components being moved such as hoods, trunk lids, tailgates, etc.

Accordingly, in an embodiment of the present disclosure, a pillar on which a door is mounted may be the mounting part B, and the process for mounting the door hinge, which is the vehicle body component A, to the mounting part B will be described as an example.

To this end, the system for mounting vehicle body components for mobility vehicles according to the present disclosure is composed of the alignment module 100, the fixing module 200, and the component support module 300.

The alignment module 100, the fixing module 200, and the component support module 300 may be configured as a robot. The alignment module 100, the fixing module 200, and the component support module 300 may be integrated into one robot or configured separately, which may be determined depending on the work space for the vehicle body component A. In an embodiment of the present disclosure, the alignment module 100, the fixing module 200, and the component support module 300 are provided on a loading robot R3, and the loading robot R3 is a robot arm that controls and changes the position of the alignment module 100, the fixing module 200, and the component support module 300 on the production line.

In this case, the alignment module 100 is used to align the vehicle body component A with the mounting part B of the mobility vehicle, and ensures that the vehicle body component A is located on one side of the mounting part B. The alignment module 100 may be configured to be movable in the vertical direction.

That is, the alignment module 100 transports the vehicle body component A to a portion where the vehicle body component A is to be mounted on the mounting part B of the mobility vehicle, so that the vehicle body component A can be fastened to the mounting part B.

Meanwhile, the fixing module 200 is provided to support the mounting part B on the opposite side of the vehicle body component A moved to the mounting part B by the alignment module 100, and is provided with the support unit 210 that contacts the other side of the mounting part B. The shape of the support unit 210 is adjusted to match the outer shape of the mounting part B, so that the support unit 210 may stably support the mounting part B by contacting to correspond to the shape of the other side of the mounting part B. In addition, in the case of the mounting part B, the shape varies depending on the various mobility. However, as the shape of the support unit 210 is adjusted to match the outer shape of the mounting part B, even if the shape of the mounting part B is diversified, the portion of the mounting part B on which the vehicle body component A is mounted may be supported in a balanced manner, minimizing installation defects and deviations in assembly upon installation of the vehicle body component A.

As such, in a state where the alignment unit 110 of the alignment module 100 positions the vehicle body component A on one side of the mounting part B while the support unit 210 of the fixing module 200 supports the other side of the mounting part B, the component support module 300 comes into contact with the vehicle body component A so that the position of the vehicle body component A is fixed.

As such, once the vehicle body component A is ready to be mounted on the mounting part B by means of the alignment module 100 and the fixing module 200, the vehicle body component A may be fastened to the mounting part B by means of a fastening robot R4.

The fastening robot R4 may attach the vehicle body component A to the mounting part B using various methods such as bolting and welding. In an embodiment of the present disclosure, the vehicle body component A is fixed to the mounting part B by a bolt fastening method using a fastening means C such as a bolt.

To describe the present disclosure described above in detail, the alignment unit 110 and the support unit 210 are arranged to face each other but are spaced apart, and the mounting part B of the mobility vehicle is located between the alignment unit 110 and the support unit 210.

That is, with the fixing module 200 installed on the alignment module 100, the alignment unit 110 and the support unit 210 are spaced apart in directions facing each other, and accordingly, the alignment unit 110 may be located on one side of the mounting part B while the support unit 210 may be located on the other side of the mounting part B. Due to this, the mounting part B is supported by the alignment unit 110 moving and contacting the vehicle body component A on one side, and the support unit 210 contacting the vehicle body component A on the other side. Accordingly, the vehicle body component A may be fastened by means of the fastening robot R4 while in contact with the mounting part B, and since the support unit 210 supports the mounting part B, deformation of the mounting part B is prevented and accurate fastening may be performed while preventing change in position of the vehicle body component A.

To describe the alignment module 100 according to the present disclosure in detail, the alignment module 100 includes: a base 120 on which a support panel 121 is formed; the alignment unit 110 movably installed on the base 120 and provided with a clamp unit 130 to which the vehicle body component A is fixed; and a first operation part 140 installed on the alignment unit 110 and connected to the support panel 121 so as to move the alignment unit 110 away from or closer to the support panel 121 during operation.

The base 120 may be installed on the loading robot R3, and the alignment unit 110 and the first operation part 140 are installed on the base 120 to move the vehicle body component A toward the vehicle body.

In this case, the alignment unit 110 is movably installed on the base 120. That is, the base 120 is provided with a guide rail 122, and the alignment unit 110 may be installed to be movable along the guide rail 122.

The alignment unit 110 is provided with the clamp unit 130, and the vehicle body component A is held by the clamp unit 130.

In addition, the first operation part 140 is installed in the alignment unit 110, so that the alignment unit 110 may be moved from the base 120 when the first operation part 140 operates. In this case, the first operation part 140 may be configured as a pneumatic cylinder or a hydraulic cylinder, and is connected to the support panel 121 formed on the base 120. Dut to this, when the first operation part 140 is operated in a tensioned manner, the alignment unit 110 moves in a direction away from the support panel 121, so that the vehicle body component A held by the clamp unit 130 may be moved toward the mounting part B.

Particularly, as the first operation part 140 is configured as a pneumatic cylinder or a hydraulic cylinder, a regulator may be further configured in a pneumatic line or hydraulic line. That is, by the operation of the first operation part 140, the vehicle body component A fixed to the clamp unit 130 moves and comes into contact with the mounting part B, but the mounting part B has a tolerance in the lateral direction of the vehicle, and thus the operating amount of the first operation part 140 to absorb the difference in the lateral position of the mounting part B that occurs within the tolerance range varies. For this reason, the regulator is further provided along with the first operation part 140, so that when the vehicle body component A and the mounting part B contact each other due to the operation of the first operation part 140, the vehicle body component A and the mounting part B are brought into contact with each other at a constant pressure, thereby preventing damage to the vehicle body component A and deterioration of fastening quality.

To further explain the tolerance upon combining the vehicle body component A according to the present disclosure, as shown in FIGS. 2 and 6, the direction in which the alignment unit is moved away from or closer to the support panel is set according to the direction of a position tolerance of the mounting part, and the range by which the alignment unit is moved away from or closer to the support panel may be set according to the degree of the position tolerance of the mounting part.

That is, the tolerance direction is the direction in which a tolerance occurs when a vehicle body component is installed from the side of the mounting part, and when the alignment unit moves away from the support panel, the tolerance decreases as the vehicle body component moved by the alignment unit gets closer to the mounting part.

Accordingly, the movement range of the alignment unit may be set according to the degree of position tolerance that occurs when the vehicle body component is mounted on the mounting part, and may be set so that the vehicle body component does not move excessively toward the mounting part and overlap, or the vehicle body component is separated from the mounting part to increase the tolerance.

Meanwhile, the clamp unit 130 includes: a seating part 131 fixed to the alignment unit 110 and formed to seat the vehicle body component A; a pressing part 132 provided to be movable toward the seating part 131 and configured to press and fix the vehicle body component A seated on the seating part 131; and a second operation part 133 installed in the alignment unit 110 and connected to the pressing part 132 so as to move the position of the pressing part 132 during operation.

That is, the seating part 131 may be fixed to the alignment unit 110, and may be formed in a “¬” shape and configured as a pair so that both flanges of a door hinge are caught when the vehicle body component A is applied as the door hinge.

The pressing part 132 is movably installed on the alignment unit 110 and is installed to move toward the seating part 131 when moved. The pressing part 132 is connected to the second operation part 133 installed in the alignment unit 110, and when the second operation part 133 operates, the pressing part 132 moves toward the seating part 131 to press the vehicle body component A seated on the seating part 131 to keep the vehicle body component A in a fixed state.

The second operation part 133 may be configured as a pneumatic cylinder or a hydraulic cylinder, and the pressing part 132 may be formed in a shape that contacts the seating part 131 so as not to be biased to one side.

In this case, a regulator may be further provided along with the second operation part 133. That is, although the vehicle body component A have different shapes and sizes, the pressure to secure the vehicle body component A needs to be within an appropriate range. By further providing the regulator together with the second operation part 133, when the pressing part 132 is moved by the operation of the second operation part 133 to fix the vehicle body component A, the vehicle body component A is fixed at a constant pressure to prevent damage to the vehicle body component A and deterioration in fastening quality.

Meanwhile, the pressing part 132 may be provided to be tiltable in the moving direction, a plurality of second operation parts 133 may be provided and arranged vertically, and the second operation parts 133 may be connected to be spaced apart in the vertical direction with the pressing part 132 in between.

As shown in FIG. 5, in an embodiment of the present disclosure, two second operation parts 133 are provided and arranged vertically, and as the second operation parts 133 are respectively connected to the upper and lower sides of the pressing part 132, depending on the advance distance of the upper second operation part 133 and the lower second operation part 133, the pressing part 132 may move and simultaneously perform a tilting operation.

That is, when the vehicle body component A is mounted on the mounting part B, the installation angle may be set differently depending on the outer shape of the mounting part B. At this time, if the pressing part 132 moves linearly with respect to the vehicle body component A to press the vehicle body component A, the vehicle body component A may not be firmly fixed and may be unstable in matching with the mounting part B.

Thus, by configuring the plurality of second operation parts 133, the pressing part 132 moves and tilts at the same time to apply the same pressure to the vehicle body component A, thereby ensuring accurate matching of the vehicle body component A to the mounting part B.

Due to this, in the alignment module 100, in a state where the vehicle body component A is seated on the seating part 131 of the clamp unit 130, the vehicle body component A is fixed in a pressed form between the pressing part 132 and the seating part 131 by the operation of the second operation part 133, and the alignment unit 110 is moved toward the mounting part B by the operation of the first operation part 140 so that the vehicle body component A may be positioned to contact one side of the mounting part B.

Meanwhile, the fixing module 200 includes: a link arm 220 installed to be moved on the alignment module 100 and equipped with the support unit 210; and a third operation part 230 installed on the alignment module 100 and connected to the link arm 220 to adjust the position of the link arm 220.

As such, the fixing module 200 consists of the link arm 220, the support unit 210, and the third operation part 230. In this case, the link arm 220 is composed of a plurality of link structures and is installed on the alignment module 100 to be rotatably movable, and the third operation part 230 is connected to the link arm 220 and adjusts the position of the link arm 220 depending on the operation thereof. In this case, the third operation part 230 may be configured as a motor, a pneumatic cylinder, or a hydraulic cylinder, and the position of the support unit 210 connected to the link arm 220 is determined by the third operation part 230.

In addition, the support unit 210 is mounted on the link arm 220 via a fourth operation part 240, and the fourth operation part 240 is configured to move in a straight line so that the position of the support unit 210 may be changed.

The fourth operation part 240 may be configured as a pneumatic cylinder or a hydraulic cylinder, is installed on the link arm 220, and moves the support unit 210 depending on the operation thereof. That is, in a state where the link arm 220 is rotated and moved and the support unit 210 is located on the other side of the mounting part B, when the fourth operation part 240 operates, the support unit 210 may be moved to contact the other side of the mounting part B and be positioned to support the mounting part B.

Due to this, in the fixing module 200, by the operation of the link arm 220, the support unit 210 may be brought into contact with the other side of the mounting part B from the opposite side of the vehicle body component A, and by the operation of the fourth operation part 240, the support unit 210 may come into contact with the other side of the mounting part B to support the mounting part B.

Meanwhile, the support unit 210 according to the present disclosure is configured to match the outer shape of the mounting part B.

As shown in FIGS. 7 to 8, the support unit 210 includes: a housing 211 having an internal space and an open surface; and a pin unit 212 having a plurality of support pins 213 provided to protrude through the open surface in the internal space of the housing 211 and elastically supported to change the protrusion lengths thereof.

As such, the pin unit 212 is provided in the housing 211, and the protrusion length of each support pin 213 constituting the pin unit 212 is changed to match the shape of the vehicle body component A.

That is, each support pin 213 is elastically supported in the housing 211 so that the protrusion length thereof changes, and as the support pins 213 protrude through the open surface of the housing 211, when the support unit 210 is positioned to contact the other side of the mounting part B, individual support pins 213 are aligned to match the outer shape of the mounting part B. The support pin 213 may be elastically supported by an elastic spring.

The position of the plurality of support pins 213 may be fixed by applying electromagnets, pneumatic pressure, or a separate mechanical contact method while being adjusted to match the outer shape of the mounting part B. As a result, in the present disclosure, as the support pins 213 are maintained in contact with the mounting part B while being matched the outer shape of the mounting part B, the mounting part B to which the vehicle body component A is fastened may be consistently and stably supported with respect to the contact surface without being biased to one side.

Meanwhile, the component support module 300 may include: a support arm 310 that moves toward the fixed vehicle body component A by means of the alignment unit 110 and contacts the vehicle body component A; and a fifth operation part 320 installed in the alignment unit 110 and connected to the support arm 310 so as to allow, when operated, the support arm 310 to move toward the vehicle body component A and make contact with the vehicle body component A.

As shown in FIG. 1, the component support module 300 consists of the support arm 310 and the fifth operation part 320. The support arm 310 is rotatably installed on the fifth operation part 320, and when the fifth operation part 320 operates, the support arm 310 rotates toward the vehicle body component A and comes into contact with the vehicle body component A to prevent the vehicle body component A from lifting.

The support arm 310 may be further provided with a contact part 311 at a portion that contacts the vehicle body component A. As the support arm 310 contacts the vehicle body component A and presses the vehicle body component A toward the mounting part B, the problem of the vehicle body component A being lifted is eliminated and the fastening position of the vehicle body component A by means of the fastening robot R4 may be correctly fixed.

Meanwhile, the apparatus for aligning vehicle body components for mobility vehicles according to the present disclosure further includes: a scanner module 500 configured to scan the mounting part B of the mobility vehicle and check the position of the vehicle body component A located on the mounting part B by the alignment module 100; and a control module 600 provided to control the alignment module 100, the fixing module 200, and the component support module 300, and configured to compare the information input through the scanner module 500 with a previously stored database 120 to identify the normal position of the vehicle body component A, and to control the alignment module 100 and the fixing module 200 to adjust the position of the vehicle body component A when the position of the vehicle body component A is determined to deviate from the normal position.

The scanner module 500 may be configured as a vision sensor. The scanner module 500 scans the mounting part B, senses the position of vehicle body component A located on the mounting part B, and transmits the corresponding information to the control module 600.

The control module 600 receives information transmitted by the scanner module 500 and determines whether the position of the vehicle body component A is normal on the basis of the previously stored database 120. In this case, the database 120 stores the normal positions of the vehicle body components A for each mobility vehicle in advance. On the basis of the database 120, the normal position of the vehicle body component A according to the mobility vehicle in which the assembly process is performed, and compare the position of the vehicle body component A input through the scanner module 500 to determine whether the vehicle body component A is correctly positioned.

In this way, when the vehicle body component A is determined to be in the correct position, the control module 600 prompts the vehicle body component A to be fastened to the mounting part B by means of the fastening robot R4, whereas when the vehicle body component A is determined to deviate from the normal position, the control module 600 controls the alignment module 100 and the fixing module 200 to adjust the position of the vehicle body component A to the correct position.

That is, on the basis of the information transmitted by the scanner module 500, the control module 600 may compare the input coordinates of the vehicle body component A with the coordinates at the normal position stored in the database 120 and measure the gap, and if the coordinates do not match, the control module 600 may adjust the coordinate values and controls the alignment module 100 and the fixing module 200 on the basis of the derived values to ensure that the vehicle body component A is positioned correctly.

As a result, the vehicle body component A is positioned correctly on the mounting part B of the mobility vehicle, minimizing deviations in assembly of the vehicle body component A. In addition, by examining and adjusting the mounting position of vehicle body component A, mounting defects and deviations in assembly are reduced, thereby improving marketability.

Meanwhile, as shown in FIG. 9, the system for mounting vehicle body components for mobility vehicles of the present disclosure includes: a bin picking robot R1 that takes out a vehicle body component A that meets the specifications of a mobility vehicle; an alignment jig R2 for seating the vehicle body component A taken out by means of the bin picking robot R1 and aligning the seated vehicle body component A at an installation angle with respect to a mounting part B; a loading robot R3 that transfers the vehicle body component A seated on the alignment jig R2 to the mounting part B, the part where the vehicle body component A is mounted in a mobility vehicle body, and allows the vehicle body component A to contact the mounting part B with a certain pressure while supporting the mounting part B; and a fastening robot R4 for fastening the vehicle body component A to the mounting part B.

The bin picking robot R1 takes out a vehicle body component A that meets the specifications of the relevant mobility, and may transport the vehicle body component A using an electromagnet or gripping means.

In addition, the vehicle body component A taken out by the bin picking robot R1 is transferred to the alignment jig R2, and as the alignment jig R2 is located within the movement range of the loading robot R3, the loading robot R3 may grip the vehicle body component A seated on the alignment jig and transfer the vehicle body component A to the mounting part B.

Particularly, the alignment jig R2 may include: a support 610 provided to seat the vehicle body component A; a first regulating device 621 for regulating one side of the vehicle body component A, and a first driving part 622 for operating the first regulating device 621; and a second regulating device 631 for regulating the other side of the vehicle body component A, and a second driving part 632 for operating the second regulating device 631.

As shown in FIGS. 11 to 13, the alignment jig R2 consists of the first regulating device 621, the first driving part 622, the second regulating device 631, and the second driving part 632, and on the support 610, the vehicle body component A is aligned at an installation angle with respect to the mounting part B by means of the first regulating device 621 and the second regulating device 631.

That is, since the mounting part B has a different shape and size, the installation angle of the vehicle body component A with respect to the mounting part B also varies. Accordingly, the alignment jig R2 receives mobility information and the installation angle of the vehicle body component A, and when the vehicle body component A is seated by means of the bin picking robot R1, the alignment jig R2 operates the first regulating device 621 and the second regulating device 631 through the operation of the first driving part 622 and the second driving part 632 to adjust and fix the installation angle of the vehicle body component A.

To be specific, the support 610 is configured to seat the vehicle body component A.

The first regulating device 621 is configured to rotate by receiving power from the first driving part 622. In this case, the first regulating device 621 contacts the upper and outer ends of the vehicle body component A when rotating toward the vehicle body component A seated on the support 610. As an example, assuming that the vehicle body component A is configured as a door hinge, the first regulating device 621 contacts the outer side of a door side plate of the door hinge coupled to a door and the outer side of a body side plate of the door hinge coupled to the vehicle body.

The second regulating device 631 is configured to advance or retreat by receiving power from the second driving part 632. Due to this, the second regulating device 631 comes into contact with the inside of the vehicle body component A seated on the support 610 when advancing by the operation of the second driving part 632. That is, when the vehicle body component A is configured as a door hinge, the second regulating device 631 contacts the inside of the body side plate.

Due to this, as the vehicle body component A is seated on the support 610 at the alignment jig R2, and then the installation angle is aligned and the position is fixed by the first regulating device 621 and the second regulating device 631, the loading robot R3 maintains the installation angle of the vehicle body component A aligned by the alignment jig R2 and matches the vehicle body component A to the mounting part B, thereby minimizing assembly tolerances and improving assembly quality.

Meanwhile, the loading robot R3 consists of: an alignment module 100 equipped with an alignment unit 110 for fixing a vehicle body component; a fixing module 200 designed to match the outer shape of the mounting part B on the other side of the mounting part B where the vehicle body component A is to be mounted; and a component support module 300 that contacts the vehicle body component A and fixes the position of the vehicle body component A while the vehicle body component A and a support unit 210 are positioned in the mounting part B. Thus, in a state where the vehicle body component A is positioned on one side of the mounting part B, and the support unit 210 of the fixing module 200 contacts and supports the other side of the mounting part B, the position of the vehicle body component A is fixed by the component support module 300, so that the vehicle body component A may be maintained in contact with the mounting part B without lifting.

Meanwhile, the fastening robot R4 allows a fastening means C to penetrate the vehicle body component A and the mounting part B fixed by the loading robot R3, so that the vehicle body component A is fixed to the mounting part B.

In the present disclosure, the fastening means C may be configured as a bolt, and the fastening robot R4 may rotate the fastening means C through motor operation so that the fastening means C is fastened through the vehicle body component A and the mounting part B. As such, the fastening robot R4 fastens and fixes the vehicle body component A located on the mounting part B by the alignment module 100 to the mounting part B via the fastening means C.

The fastening robot R4 may be configured as a welder in addition to performing bolting fastening depending on the fastening method of the vehicle body component A.

In this way, the present disclosure can improve production speed through an automated process when assembling vehicle body components into a mobility vehicle body.

According to an embodiment of the present disclosure described above, the mounting process of the vehicle body component A may be performed as follows.

As shown in FIG. 10, mobility information is acquired and the vehicle body component A corresponding to the mobility vehicle is taken out by the bin picking robot R1.

As shown in FIGS. 11 to 13, the vehicle body component A taken out by means of the bin picking robot R1 is transferred to the alignment jig, and the alignment jig aligns the vehicle body component A at an installation angle according to the matching surface of the mounting part B of the mobility vehicle.

In this way, the vehicle body component A aligned by the alignment jig is moved to the mounting part by the loading robot R3. That is, as shown in FIG. 2, when the vehicle body component A is disposed on the mounting part B, the vehicle body component A is located on one side of the mounting part B of the mobility vehicle by means of the alignment unit 110 of the alignment module 100, and the support unit 210 of the fixing module 200 contacts the other side of the mounting part B.

At this time, the alignment unit 110 is moved by a first operation part 140 so that the vehicle body component A contacts the mounting part B with a constant pressure, thereby eliminating tolerance.

Meanwhile, as shown in FIG. 14, by a scanner module 500, the position of the vehicle body component A is checked, and whether the position of the vehicle body component A is normal is determined. At this time, when the position of the vehicle body component A is determined to deviate from the normal position, the position of the vehicle body component A is adjusted by controlling the alignment module 100 and the fixing module 200 on the basis of data regarding the normal position of the vehicle body component A.

Through this process, when the vehicle body component A is positioned correctly in the mounting part B, as shown in FIG. 15, the vehicle body component A is pressed by means of the component support module 300 so that the vehicle body component A does not lift off the mounting part B, thereby regulating the position of the vehicle body component A.

Finally, as shown in FIG. 16, the vehicle body component A is fastened to the mounting part B via the fastening means C by the fastening robot R4.

Meanwhile, as shown in FIG. 17, the method for mounting vehicle body components for mobility vehicles according to the system for mounting vehicle body components for mobility vehicles of the present disclosure includes: taking out (S10) in which a vehicle body component A is taken out by a bin picking robot R1 on the basis of mobility information; aligning (S20) in which the taken-out vehicle body component A is transferred to an alignment jig and seated on the alignment jig; preparing fastening (S30) in which the vehicle body component A is positioned on one side of a mounting part B of a mobility vehicle by an alignment module 100 of a loading robot R3 while a fixing module 200 is brought into contact with the other side of the mounting part B, and a component support module 300 is brought into contact with the vehicle body component A; and fastening (S40) in which the vehicle body component A is fastened to the mounting part B via a fastening means C by a fastening robot R4.

In this case, the method may further include checking (S50), after the step of preparing fastening (S30), in which the position of the vehicle body component A is checked and whether the position of the vehicle body component A is normal is determined on the basis of a database 120 by a scanner module 500.

In addition, the method may further include adjusting (S600) in which the alignment module 100 and the fixing module 200 are controlled to adjust the position of the vehicle body component A when the position of the vehicle body component A is determined, in the step of checking (S50), to deviate from the normal position.

To be specific, as shown in FIG. 18, after a process of acquiring (S11) mobility information, a process of taking out (S12) the vehicle body component A corresponding to the mobility vehicle by means of the bin picking robot R1 is performed.

As such, the vehicle body component A taken out by the bin picking robot R1 is transferred to the alignment jig, and the alignment jig performs a process of aligning (S21) the transferred vehicle body component A at the installation angle, so that the vehicle body component A is prepared to be matched to the mounting part B of the mobility vehicle.

Thereafter, a process (S31) in which the vehicle body component A seated on the alignment jig is positioned on one side of the mounting part B of the mobility vehicle by the alignment unit 110 of the alignment module 100 as the loading robot R3 is driven, a support unit 210 of the fixing module 200 is brought into contact with the other side of the mounting part B, and the component support module 300 is brought into contact with the vehicle body component A.

At this time, a process of checking (S51) the position of the vehicle body component A by the scanner module 500 is performed, and a process of determining (S52) whether the position of the vehicle body component A is normal is performed.

In this case, when the position of the vehicle body component A is determined to deviate from the normal position, a process of calculating (S61) data to correct the position of the vehicle body component A is performed, and a process of adjusting (S62) the position of the vehicle body component A is performed by controlling the alignment module 100 and the fixing module 200 using the calculated data.

Once the vehicle body component A is determined to be in correct position in the mounting part B, a process of fastening (S41) the vehicle body component A to the mounting part B via the fastening means C by the fastening robot R4 is performed.

The system and method having the structure described above for mounting vehicle body components for mobility vehicles ensure that body components are mounted to the correct positions in various types of mobility vehicles.

That is, since stable support is provided in response to the shape of a part to which a body component is mounted in various types of mobility vehicles, deviations in assembly of body components may be minimized, and through examination and adjustment of body component mounting positions, installation defects and deviations in assembly may be reduced, improving marketability.

Although the present disclosure was provided above in relation to specific embodiments shown in the drawings, it is apparent to those skilled in the art that the present disclosure may be changed and modified in various ways without departing from the scope of the present disclosure, which is provided in the following claims.

### DESCRIPTION OF NUMERALS

100: alignment module 110: alignment unit
120: base 121: support panel
130: clamp unit 131: seating part
132: pressing part 133: second operation part
140: first operation part 200: fixing module
210: support unit 211: housing
212: pin unit 220: link arm
230: third operation part 240: fourth operation part
300: component support module 310: support arm
311: contact part 320: fifth operation part
400: scanner module 500: control module
610: support 621: support
621: first regulating device 622: first driving part
631: second regulating device 632: second driving part
R1: bin picking robot R2: alignment jig
R3: loading robot R4: fastening robot
A: vehicle body component B: mounting part
C: fastening means S10: taking out
S20: aligning S30: preparing fastening
S40: fastening S50: checking
S60: adjusting

1. An apparatus for aligning vehicle body components for mobility vehicles, the apparatus comprising:
an alignment module provided with an alignment unit configured to be movable to position a vehicle body component on a first side of a mounting part, which is a part where the vehicle body component is mounted in a mobility vehicle body; and
a fixing module provided with a support unit configured to contact a second side of the mounting part, wherein the support unit is designed to match an outer shape of the mounting part.

2. The apparatus of claim 1, wherein the alignment module and the fixing module are configured as one device such that the fixing module is mounted on the alignment module, and
the alignment module and the fixing module are arranged to face each other but are spaced apart, so that the mounting part of a mobility vehicle is located between the alignment unit and the support unit.

3. The apparatus of claim 1, wherein the alignment module comprises:
a base on which a support panel is provided;
the alignment unit movably installed on the base and provided with a clamp unit to which the vehicle body component is fixed; and
a first operation part installed on the alignment unit and connected to the support panel so as to move the alignment unit away from or closer to the support panel during operation.

4. The apparatus of claim 3, wherein a direction in which the alignment unit is moved away from or closer to the support panel is set according to a direction of a position tolerance of the mounting part, and
a range by which the alignment unit is moved away from or closer to the support panel is set according to a degree of the position tolerance of the mounting part.

5. The apparatus of claim 3, wherein the clamp unit comprises:
a seating part fixed to the alignment unit and provided to seat the vehicle body component;
a pressing part provided to be movable toward the seating part and configured to press and fix the vehicle body component seated on the seating part; and
a second operation part installed in the alignment unit and connected to the pressing part so as to move a position of the pressing part during operation.

6. The apparatus of claim 5, wherein the pressing part is provided to be tiltable in a moving direction,
a plurality of second operation parts is provided and arranged vertically, and
the second operation parts are connected to be spaced apart in a vertical direction with the pressing part in between.

7. The apparatus of claim 1, wherein the fixing module comprises:
a link arm installed to be moved on the alignment module and equipped with the support unit; and
a third operation part installed on the alignment module and connected to the link arm to adjust a position of the link arm.

8. The apparatus of claim 7, wherein the support unit is mounted on the link arm via a fourth operation part, and the fourth operation part is configured to move in a straight line so that a position of the support unit is changed.

9. The apparatus of claim 1, wherein the support unit comprises:
a housing configured to have an internal space and an open surface; and
a pin unit configured to have a plurality of support pins provided to protrude through the open surface in the internal space of the housing and elastically supported to change protrusion lengths thereof.

10. The apparatus of claim 1, further comprising:
a component support module configured to contact the vehicle body component and fix a position of the vehicle body component in a state where the vehicle body component is positioned on the first side of the mounting part by the alignment unit of the alignment module while the support unit of the fixing module contacts and supports the second side of the mounting part.

11. The apparatus of claim 10, wherein the component support module comprises:
a support arm configured to move toward the fixed vehicle body component by means of the alignment unit and contact the vehicle body component; and
a fifth operation part installed in the alignment unit and connected to the support arm so as to allow, when operated, the support arm to move toward the vehicle body component and make contact with the vehicle body component.

12. The apparatus of claim 1, further comprising:
a scanner module configured to scan the mounting part of the mobility vehicle and check a position of the vehicle body component located on the mounting part by the alignment module; and
a control module configured to compare information input through the scanner module with a previously stored database to identify a normal position of the vehicle body component, and to control the alignment module and the fixing module to adjust the position of the vehicle body component when the position of the vehicle body component is determined to deviate from the normal position.

13. A system for mounting vehicle body components for mobility vehicles, the system comprising:
a bin picking robot configured to take out a vehicle body component that meets specifications of a mobility vehicle;
an alignment jig configured to seat the vehicle body component taken out by the bin picking robot and align the seated vehicle body component at an installation angle with respect to a mounting part;
a loading robot configured to transfer the vehicle body component seated on the alignment jig to the mounting part, a part where the vehicle body component is mounted in a mobility vehicle body, and allow the vehicle body component to contact the mounting part with a certain pressure while supporting the mounting part; and
a fastening robot configured to fasten the vehicle body component to the mounting part.

14. The system of claim 13, wherein the loading robot comprises:
an alignment module provided with an alignment unit for fixing the vehicle body component;
a fixing module designed to match an outer shape of the mounting part on a second side of the mounting part where the vehicle body component is to be mounted; and
a component support module configured to contact the vehicle body component and fix a position of the vehicle body component while the vehicle body component and a support unit are positioned in the mounting part.

15. The system of claim 13, wherein the alignment jig comprises:
a support provided to seat the vehicle body component;
a first regulating device configured to regulate a first side of the vehicle body component, and a first driving part configured to operate the first regulating device; and
a second regulating device configured to regulate a second side of the vehicle body component, and a second driving part configured to operate the second regulating device.

16. The system of claim 13, wherein the fastening robot allows a fastening means to penetrate the vehicle body component and the mounting part fixed by the loading robot, so that the vehicle body component is fixed to the mounting part.

17. A method for mounting vehicle body components for mobility vehicles to properly position and mount the vehicle body components on a mobility vehicle body, the method comprising:
taking out in which a vehicle body component is taken out by a bin picking robot on a basis of mobility information;
aligning in which the taken-out vehicle body component is transferred to an alignment jig and seated on the alignment jig;
preparing fastening in which the vehicle body component is positioned on a first side of a mounting part of a mobility vehicle by an alignment module of a loading robot while a fixing module is brought into contact with a second side of the mounting part, and a component support module is brought into contact with the vehicle body component; and
fastening in which the vehicle body component is fastened to the mounting part via a fastening means by a fastening robot.

18. The method of claim 17, wherein in the aligning, the seated vehicle body component is aligned at an installation angle for the mounting part of the mobility vehicle on the basis of the mobility information.

19. The method of claim 17, further comprising:
checking, after the preparing fastening, in which a position of the vehicle body component is checked and whether the position of the vehicle body component is normal is determined on a basis of a database by a scanner module.

20. The method of claim 19, further comprising:
adjusting in which the alignment module and the fixing module are controlled to adjust the position of the vehicle body component when the position of the vehicle body component is determined, in the checking, to deviate from the normal position.
